(19) United States
(12) Patent Application Publication
(10) Pub. No.: US 2014/0258088 A1
(43) Pub. Date: Sep. 11, 2014

(54) Method and System for Providing Loans Based on the Repayment Capacity of a Customer

(71) Applicant: Mohammed Belarj, Dubai (AE)

(72) Inventor: Mohammed Belarj, Dubai (AE)

(21) Appl. No.: 13/792,580

(22) Filed: Mar. 11, 2013

(51) Int. Cl. G06Q 40/02

(52) U.S. Cl. CPC G06Q 40/025; G06Q 20/102
USPC 705/38

(57) ABSTRACT

A method and system for efficiently providing loans based on the repayment capacity of a customer for providing a customer with one or more repayment options for a loan that satisfy a repayment capacity for the customer. The method and system for efficiently providing loans based on the repayment capacity of a customer generally includes calculating a repayment capacity for a customer, providing the customer with a payment card, selecting an item for purchase by the customer from a merchant, requesting a loan from the issuer by the customer, determining if the customer has sufficient repayment capacity, providing the customer one or more repayment options that satisfy the repayment capacity, selecting a repayment option by the customer and transferring funds from the issuer to the merchant for the purchase amount.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a loan system and more specifically it relates to a method and system for efficiently providing loans for the purpose of purchasing goods and services, or loan without interest where a financial institution initially acquires the goods and then sells them to the customer at a profit, by means of a device issued for a preapproved monthly repayment amount.

2. Description of the Related Art

Any discussion of the related art throughout the specification should in no way be considered as an admission that such related art is widely known or forms part of common general knowledge in the field.

A loan involves a borrower receiving an amount of money called principal from a lender, wherein the borrower is obligated to pay back the money to the lender at a later time. Most loans are provided at a cost to the borrower referred to as interest. Interest in a loan is typically compounded and calculated on a daily, monthly or yearly basis.

A common type of loan is an “installment loan” (a.k.a. consumer loans) wherein the loan is repaid over a period of time with a set number of scheduled payments of principal and interest. The term of the installment loan may be a few months or as long as 30 years. Types of installment loans include home mortgages and vehicle loans. Another type of loan is a “payday loan” or “payday advance” which is a small, short-term unsecured loan. Another type of loan is comprised of financial credit provided by credit cards also known as revolving credit where the borrower utilizes a card to make purchases.

Islamic banking (a.k.a. participant banking) is banking activity that is consistent with the principles of sharia and its practical application through the development of Islamic economics. In particular, sharia prohibits the fixed or floating payment or acceptance of specific interest for loans of money. Islamic banking often times involves the lender purchasing the goods/services, then reselling the goods/services to the borrower at a profit while allowing the borrower to pay the lender in installment payments. In that manner, a loan transaction is transformed into a purchase transaction paid over time. In this scenario, the profit on a commercial transaction replaces the interest rate and is permitted. There typically can be no penalty if the borrower does not timely pay the loan.

One of the main problems with loans is they require the borrower to apply to the lender directly each time they want to purchase a new good or service which is time consuming. Another problem with loans is they often times require the borrower to physically meet with the lender to sign loan papers. These issues are aggravated when the financial institution has to initially buy the goods needed by its customer and resell them to the customer, adding to the paperwork necessary and the time required for this process.

Because of the inherent problems with the related art, there is a need for a new and improved method and system for efficiently providing installment purchase loans based on the repayment capacity of a customer for providing a customer with one or more repayment options for a loan that satisfy a repayment capacity for the customer.

### BRIEF SUMMARY OF THE INVENTION

The invention generally relates to an installment purchase loan system which includes calculating a repayment capacity for a customer, providing the customer with a payment card, selecting an item for purchase by the customer from a merchant, requesting a loan or the purchase of the goods from the issuer by the customer and the reselling of the same to the customer, determining if the customer has sufficient repayment capacity, providing the customer one or more repayment options that satisfy the repayment capacity, selecting a repayment option by the customer and transferring funds from the issuer to the merchant for the purchase amount.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram illustrating the overall communications within the present invention.

FIG. 2 is a block diagram illustrating the communications within the present invention via a communications network.

FIG. 3 is a flowchart illustrating the enrollment process for the present invention.

FIG. 4a is a flowchart illustrating the preapproval of a customer by an issuer.

FIG. 4b is a flowchart illustrating the preapproval of a merchant by an acquirer.

FIG. 5a is a flowchart illustrating the overall operation of the present invention.

FIG. 5b is a flowchart continuing from FIG. 5a illustrating overall operation of the present invention.

FIG. 5c is a flowchart continuing from FIG. 5b illustrating overall operation of the present invention.

FIG. 6a is a flowchart illustrating the overall operation of the present invention utilizing an application on the payment card.

FIG. 6b is a flowchart continuing from FIG. 5a illustrating overall operation of the present invention utilizing an application on the payment card.

FIG. 7 is a flowchart illustrating he overall process for the present invention allowing for multiple loans to be created for the customer based on the customer's repayment capacity.

FIG. 8a is a top view illustrating an exemplary payment terminal displaying a plurality of payment plan options.

FIG. 8b is a top view illustrating the exemplary payment terminal displaying a selected payment plan.

FIG. 9a is a top view illustrating the exemplary payment terminal displaying a summary of the last transaction for the customer with the payment card.

FIG. 9b is a top view illustrating the exemplary payment terminal displaying a summary of the last three transactions for the customer with the payment card.

FIG. 10a is a top view illustrating an exemplary payment terminal displaying a plurality of payment plan options for an Islamic banking version of the present invention.

FIG. 10b is a top view illustrating the exemplary payment terminal displaying a selected payment plan for an Islamic banking version of the present invention.

FIG. 10c is a top view illustrating the exemplary payment terminal displaying purchase information for the issuer to purchase the item from the merchant for an Islamic banking version of the present invention.

### DETAILED DESCRIPTION OF THE INVENTION

### A. Overview of Invention.

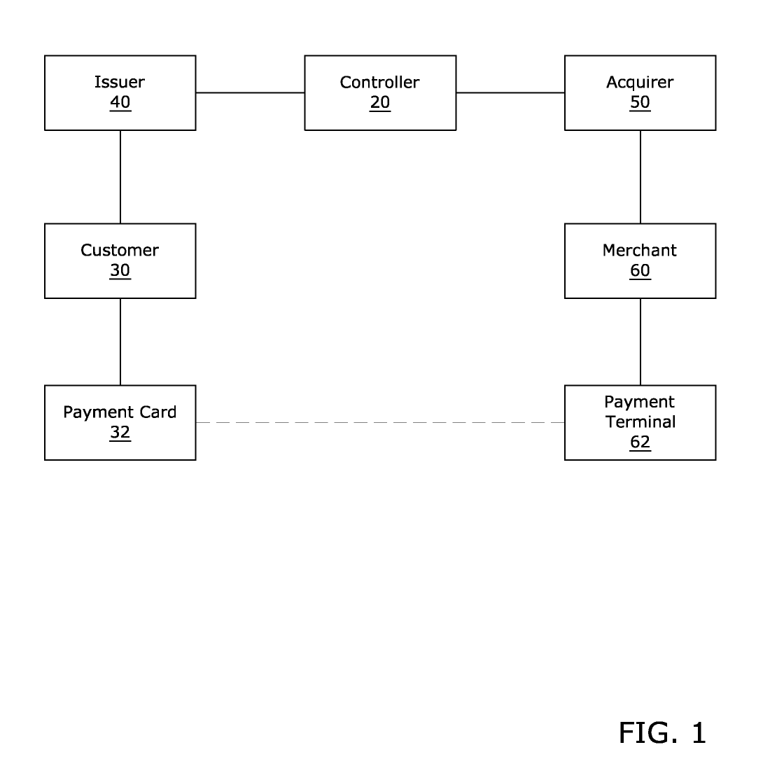

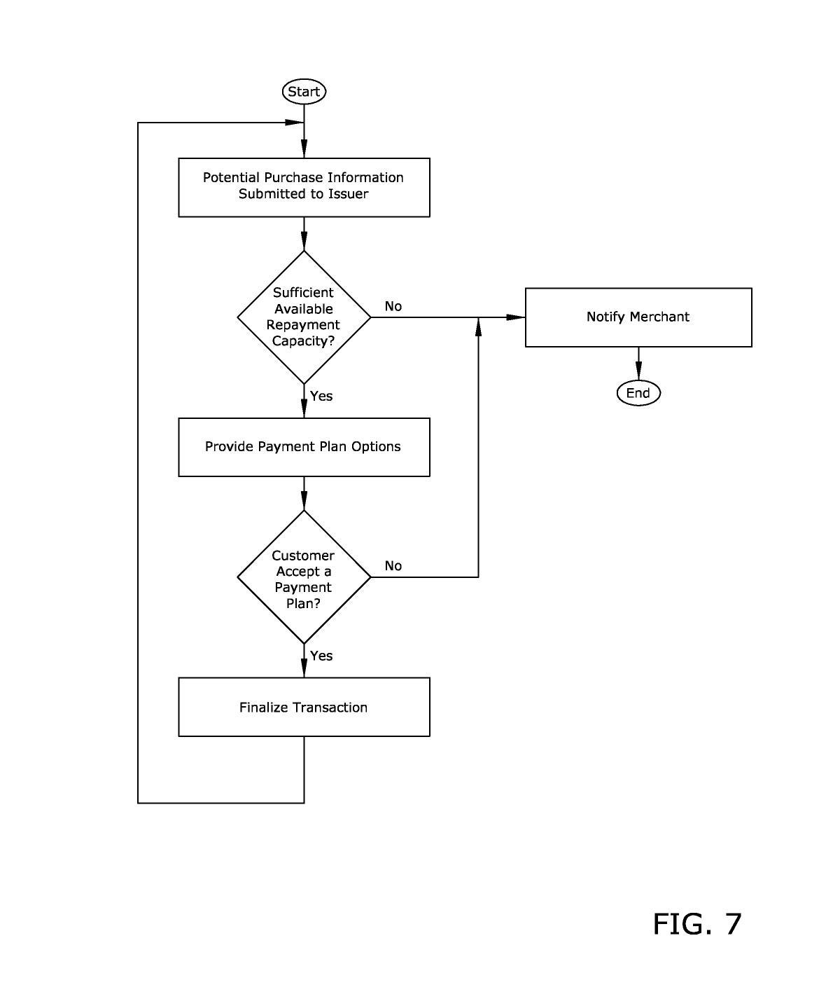

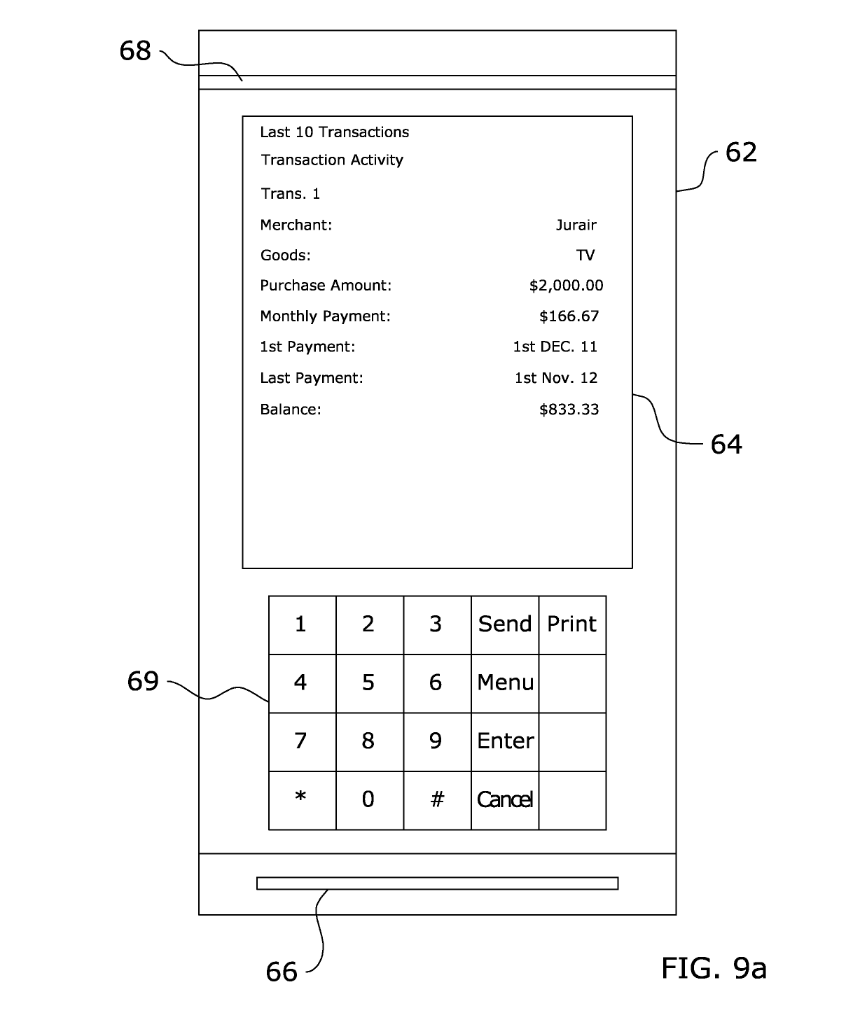

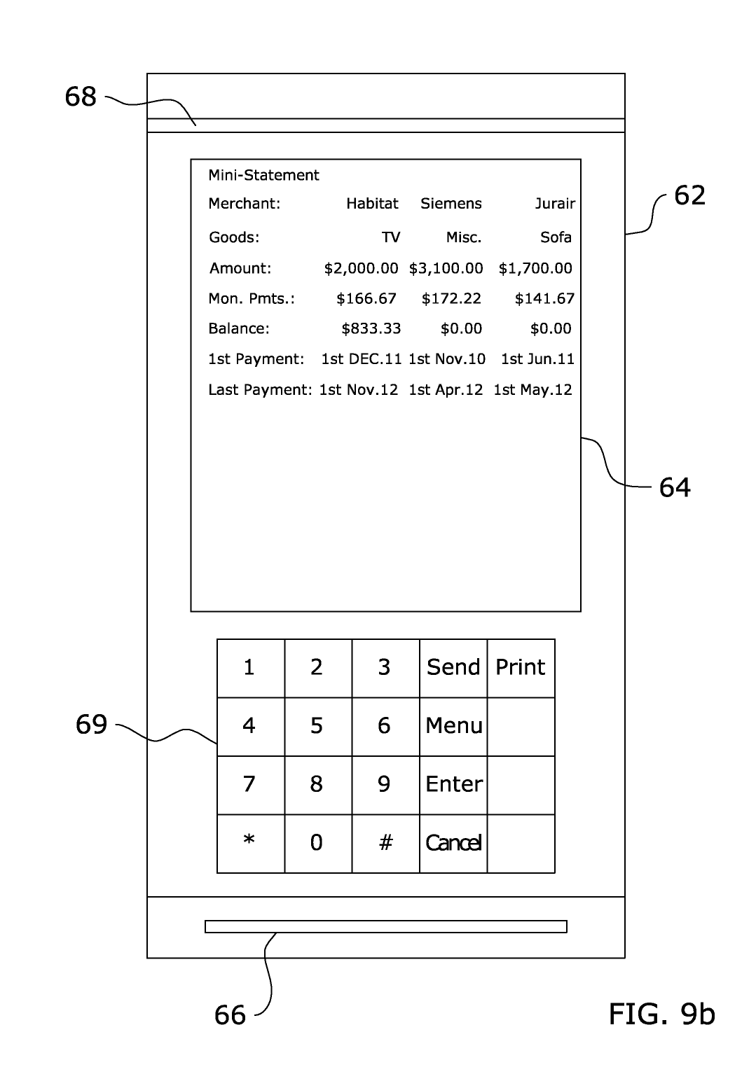

FIGS. 1 through 10c illustrate the present invention. The method and system for efficiently providing installment purchase loans based on the repayment capacity of a customer 30 generally includes calculating a repayment capacity for a customer 30, providing the customer 30 with a payment card 32, selecting an item for purchase by the customer 30 from a merchant 60, requesting a loan from the issuer 40 by the customer 30, determining if the customer 30 has sufficient repayment capacity, providing the customer 30 one or more repayment options that satisfy the repayment capacity, selecting a repayment option by the customer 30 and transferring funds from the issuer 40 to the merchant 60 for the purchase amount.

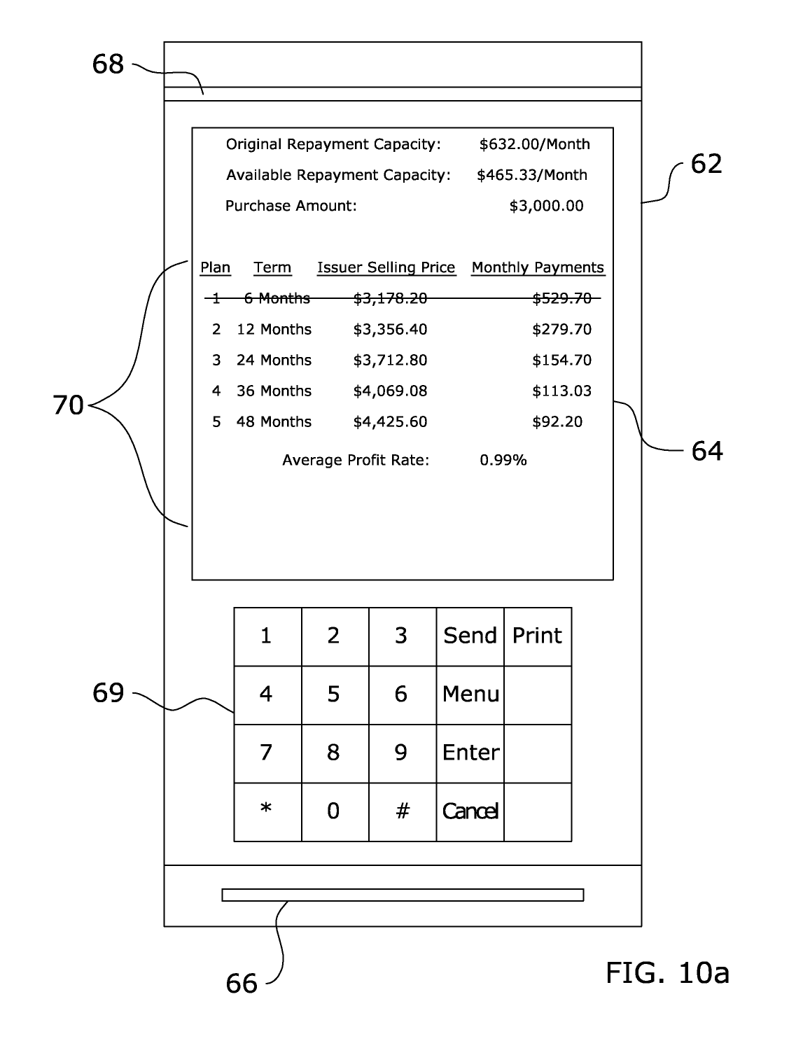

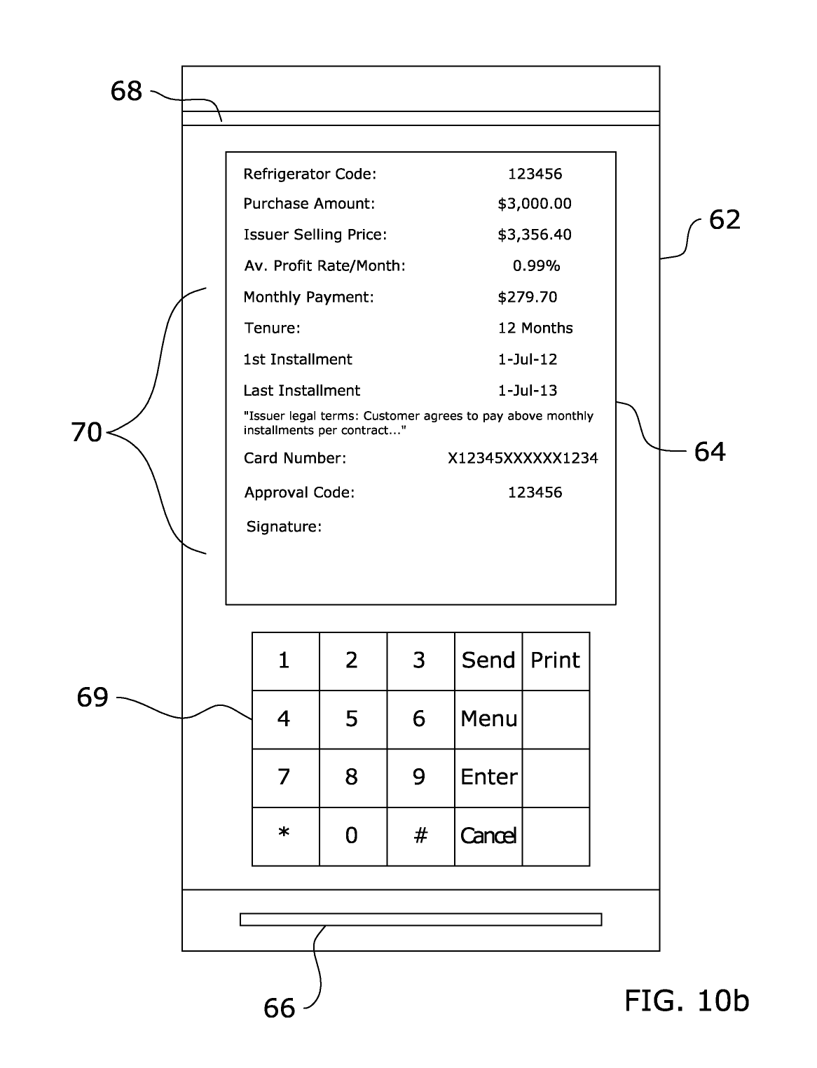

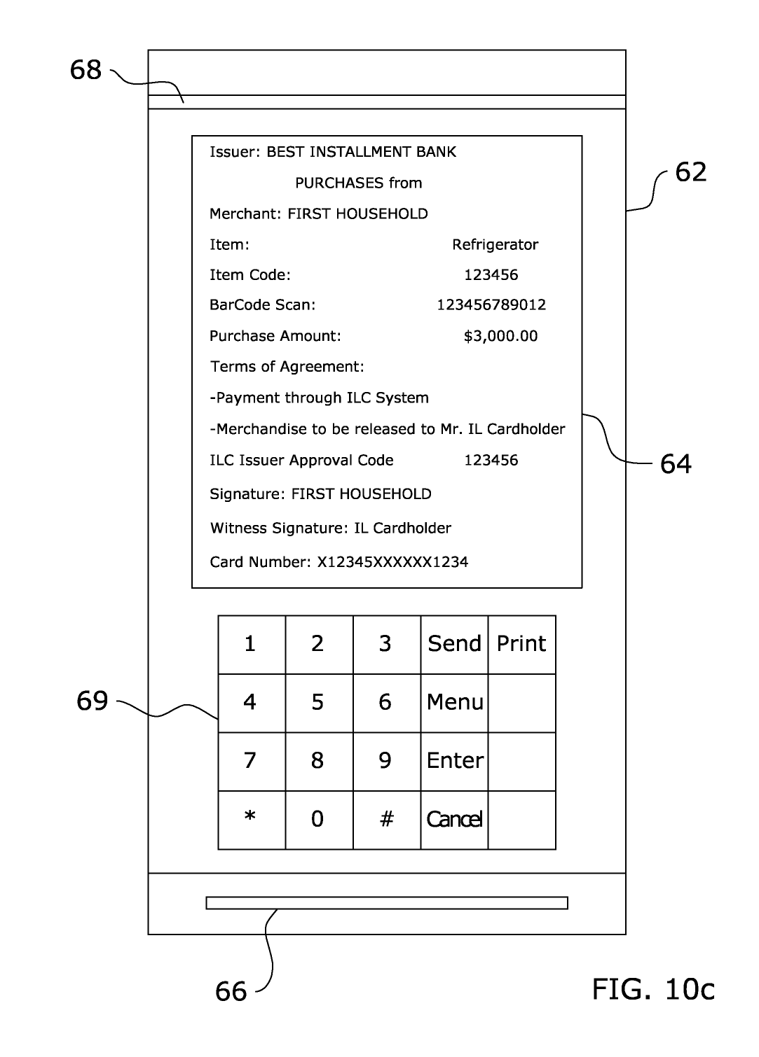

FIGS. 10a through 10c illustrate an alternative embodiment of the present invention involving an Islamic banking system wherein the issuer 40 purchases the item from the merchant 60 and then resells the item to the customer 30. In particular, the Islamic embodiment of the present invention includes selecting an item needed by the customer 30 for purchase by the issuer 40 from the merchant 60, and then selling the same item to the customer 30 by the issuer 40 on installment and with a profit margin.

An “item” for purchase by customer 30 and/or the issuer 40 as used in the present invention may be comprised of anything capable of being purchased such as but not limited to any good, service or combination of goods/services.

### B. Customer.

The customer 30 is comprised of any individual or entity that requires access to one or more installment purchase loan in the future from the issuer 40 to purchase one or more items. The customer 30 applies for preapproval for an installment purchase loan account with the issuer 40 which provides the customer 30 with access to one or more loans via the loan account as long as the total periodic payments for all of the installment purchase loans in the loan account do not exceed the available repayment capacity associated with the loan account. The customer 30 may have a computer system that allows them to access their account information with the issuer 40 via the telecommunications network 12.

### C. Issuer.

The issuer 40 is an entity that enrolls the customers 30. It is comprised of a financial institution utilized by the customer 30. The issuer 40 may be comprised of various types of financial entities such as but not limited to a bank or credit union. The issuer 40 is responsible for all KYC (know your customer) and due diligence on the customers 30 it enrolls into the system.

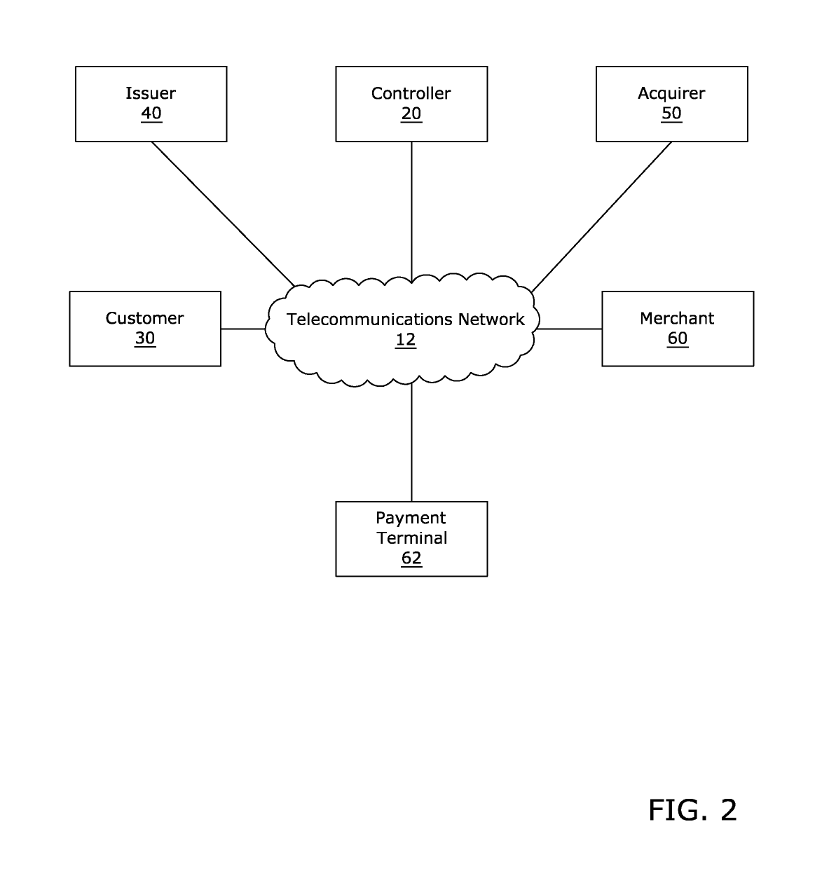

The issuer 40 includes a computer system that creates, stores, updates and retrieves the customers information including name, address, loan account, loan account identifier, account password, personal identification number (PIN), transaction history for loan account, original repayment capacity for loan account, currently available repayment capacity. The computer system of the issuer 40 communicates with the payment terminal 62 of the merchant 60 via a suitable telecommunications network 12 as illustrated in FIG. 2 of the drawings.

### D. Loan Account.

1. Overview.

When the customer 30 is preapproved by the issuer 40 for an installment purchase loan account, the loan account is created within the computer system of the issuer 40. The loan account is a financial account that is associated with one or more loans provided to the customer 30. The loan account includes a database that includes information relating to the customer 30 (e.g. name, address, citizenship, telephone numbers, e-mail address), account identifier (e.g. account number), personal identification number (PIN) associated with the customer 30 to protect access to the loan account, the original repayment capacity for the customer 30, the available repayment capacity for the customer 30, individual loan details (e.g. purchase amount, interest rate, profit rate, term, payment type, amount of periodic payments, first payment date, last payment date). The number of loans within the loan account is not set and the only limit on the customer 30 receiving additional funds from the loan account is their available repayment capacity. The credit history and amount of a loan is not used to determine if the customer 30 is able to receive a loan for the purchase of an item.

2. Original Repayment Capacity.

The customer 30 applies for preapproval for an original repayment capacity determination which is the total amount of money the customer 30 is capable of repaying on the loan account with the issuer 40 in periodic payments as determined by the issuer 40. The original repayment capacity is comprised of a portion of revenues for the customer 30 as determined by the issuer 40. The original repayment capacity may be various periodic payment allowances such as daily, weekly, bi-monthly, monthly, quarterly and yearly. However it is preferable that the original repayment capacity be based on a monthly amount of money the customer 30 is allowed for repaying all of the loans provided to the customer 30 under the loan account with the issuer 40.

For example, if the customer 30 has a monthly income of $4,000 per month, the issuer 40 may set the original repayment capacity at $632 per month (less or more at the sole discretion of the issuer 40. In furtherance of the example, the customer 30 is allowed to take out as many loans as desired to purchase various types of items as long as the total monthly payments for the loans do not exceed the original repayment capacity.

3. Available Repayment Capacity.

When the customer 30 requests a loan from the issuer 40, the issuer 40 determines the available repayment capacity and provides payment plan options 70 to the customer 30 that are within the available repayment capacity. The available repayment capacity is comprised of the original repayment capacity reduced by a total of payments for current loans to the customer 30. As with the original repayment capacity, the available repayment capacity may be various periodic payment allowances such as daily, weekly, bi-monthly, monthly, quarterly and yearly. However it is preferable that the available repayment capacity be based on a monthly amount of money the customer 30 is allowed for repaying future loans provided to the customer 30 under the loan account with the issuer 40.

For example, if the customer 30 has an original repayment capacity of $632 per month and has taken out a first loan and a second loan from the loan account with monthly payments of $100 per month and $156.67 respectively, the available repayment capacity for the customer 30 is $375.33 per month. If the customer 30 takes out a third loan from the issuer 40 with monthly payments of $200 per month, then the available repayment capacity is lowered to $175.33 per month. After the third loan from the loan account, the customer 30 is only able to take out a fourth loan if the payments are at or below $175.33 per month.

### E. Payment Card.

Upon approval of the customer 30 by the issuer 40, the issuer 40 will issue a payment card 32 associated with the loan account. The payment card 32 may be comprised of any type of card suitable for providing information about the loan account such as a magnetic stripe card, re-programmable magnetic stripe card, a smart card (a.k.a. chip card or integrated circuit card), contact smart card, contactless smart card (e.g. RFID card), a hybrid smart card or a mobile device (SIM) card or application on card (cellphone, smart phone or tablets). The payment card 32 is preferably comprised of a size and structure similar to a conventional credit card, however, the payment card 32 may be comprised of various other structures. The payment card 32 preferably is capable of providing identification of the customer 30, authentication, data storage and application processing. The payment card 32 preferably is capable of receiving, storing, updating and transmitting data such as the original repayment capacity, transaction amounts. or the available repayment capacity.

The payment card 32 preferably includes embedded integrated circuits (e.g. memory, microprocessor) that can process data. The payment card 32 is preferably comprised of a smart card with integrated circuits further preferably includes a smart card operating system that in combination with the integrated circuitry provides basic functionality such as secure access to the on-card storage, authentication, encryption, programs and applications loaded on the payment card 32. The smart card may also have a multi-application card operating system (MACOS) that allows for the development of multiple applications and programs that can run on a single payment card 32 similar to a computer program. The programs and the applications on the payment card 32 are similar to software programs on a computer system that extend the basic functionality of the smart card operating system. Examples of smart card operating system suitable for usage within the present invention include Java Card that allows Java-based applications to run securely on smart cards and MULTOS which provides a virtual machine that provides application run-time environment, memory management and application loading/deleting. Java Card products may be based on the Java Card Platform specifications developed by SUN MICROSYSTEMS (a subsidiary of ORACLE CORPORATION) or GlobalPlatform open platform specifications. U.S. Pat. No. 8,266,619 illustrates a suitable smart card and an embedded operating system for a smart card suitable for use within the present invention and is hereby incorporated by reference.

### F. Acquirer.

The acquirer 50 is an entity that enrolls the merchants 60. It is comprised of a financial institution utilized by the merchant 60 for financial transactions. The acquirer 50 may be comprised of various types of financial entities such as but not limited to a bank or credit union. The issuer 40 and the acquirer 50 may be the same entity or different entities. The controller 20 may also be the same as the issuer 40 and the acquirer 50. The acquirer 50 receives funds electronically from the issuer 40 and deposits the funds into an account associated with the merchant 60. The acquirer 50 is responsible for all KYC (know your customer) and due diligence on the merchants 60 it enrolls into the system.

### G. Merchant.

The merchant 60 may be comprised of any individual or entity that is selling items to customers 30. For example, the merchant 60 may be a retail appliance store, an automobile dealer, a furniture store, an electronics store, a computer store, service provider and the like. The merchant 60 includes a computer system for communicating with the computer systems of the customer 30, the acquirer 50, the controller 20 and/or the issuer 40 via the telecommunications network 12.

### H. Payment Terminal.

The payment terminal 62 may be comprised of any type of point of sale (POS) terminal that is capable of communicating with the payment card 32 and/or that allows for the manual entry of customer 30 information such as but not limited to a credit card terminal. The payment terminal 62 allows the customer 30 or merchant 60 to insert, swipe, wirelessly communicate, and/or manually key in the customer 30 information (e.g. account number, PIN) and transmit the data to the issuer 40 through the acquirer 50 and the controller 20 for authorization of the purchase of the item. The payment terminal 62 may be comprised of any electronic device capable of receiving and transmitting data such as but not limited to a computer system, a smartphone.

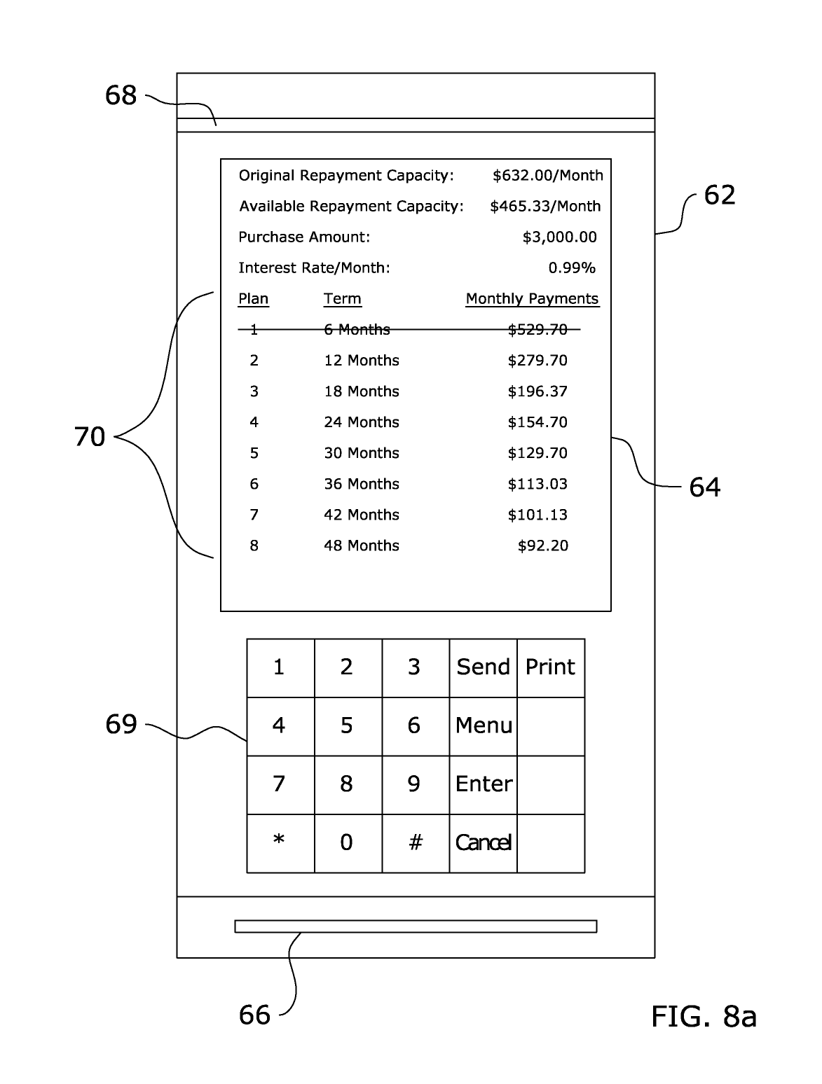

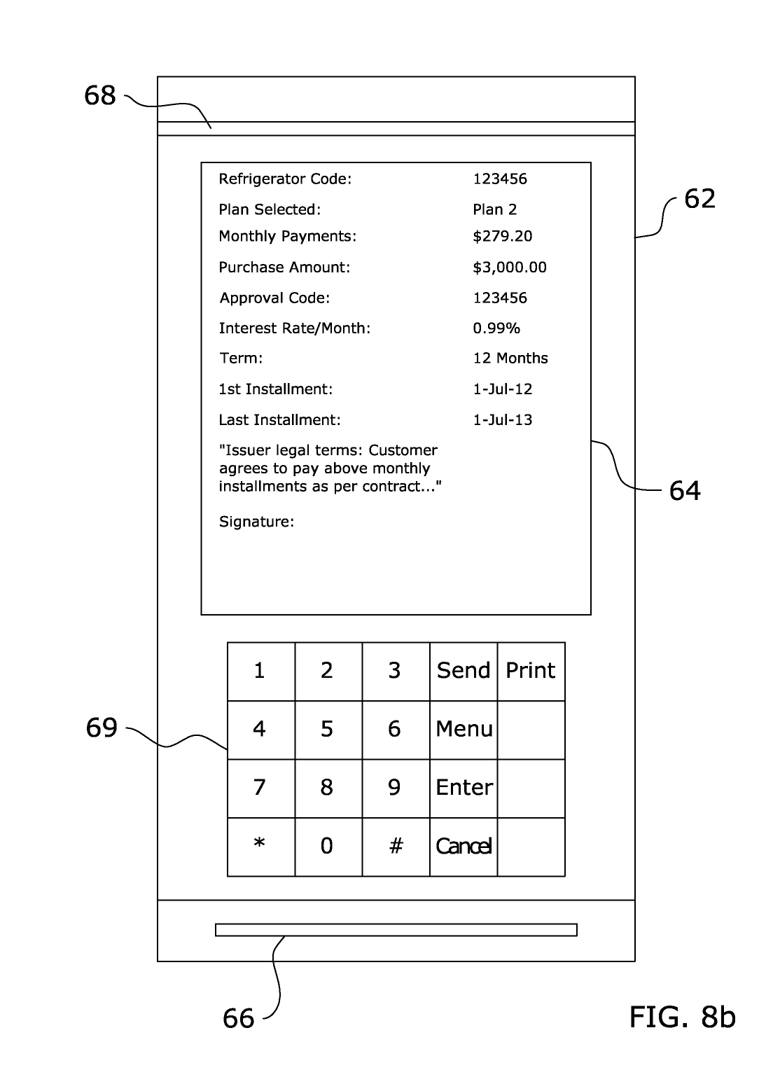

FIG. 8a illustrates an exemplary payment terminal 62 having a central processing unit, a display screen 64 in communication with the central processing unit to display information to the merchant 60 and customer 30, a printer 66 for printing information for the merchant 60 and customer 30 (e.g. receipts, payment plan options 70, original repayment capacity, available repayment capacity, repayment contracts, loan documents, etc.), a card reader 68 for receiving data from the payment card 32 (e.g. magnetic strip reader, RFID unit, transceiver) and a keypad 69 for entering information into the payment terminal 62 (e.g. account number, customer 30 information, PIN, password, purchase amount, item selection). It can be appreciated that the keypad 69 may be a touchscreen separate or part of the display screen 64.

The payment terminal 62 may be comprised of any type of computer for practicing the various aspects of the present invention. For example, the payment terminal 62 can be a point of sale, POS (e.g. VERIFONE®), a cash register (e.g. NCR SILVER®), a Self-Service machine (e.g. NCR SELFSERV® series), a personal computer (e.g. APPLE® based computer, an IBM based computer, or compatible thereof) or tablet computer (e.g. IPAD®). The payment terminal 62 may also be comprised of various other electronic devices capable of sending and receiving electronic data including but not limited to smartphones, mobile phones, telephones, personal digital assistants (PDAs), mobile electronic devices, handheld wireless devices, two-way radios, smart phones, communicators, video viewing units, television units, television receivers, cable television receivers, pagers, communication devices, and digital satellite receiver units.

The payment terminal 62 may be comprised of any conventional computer. A conventional computer preferably includes a display screen 64 (or monitor), a printer 66, a hard disk drive, a network interface, and a keyboard. A conventional computer also includes a microprocessor, a memory bus, random access memory (RAM), read only memory (ROM), a peripheral bus, and a keyboard controller. The microprocessor is a general-purpose digital processor that controls the operation of the computer. The microprocessor can be a single-chip processor or implemented with multiple components. Using instructions retrieved from memory, the microprocessor controls the reception and manipulations of input data and the output and display of data on output devices. The memory bus is utilized by the microprocessor to access the RAM and the ROM. RAM is used by microprocessor as a general storage area and as scratch-pad memory, and can also be used to store input data and processed data. ROM can be used to store instructions or program code followed by microprocessor as well as other data. A peripheral bus is used to access the input, output and storage devices used by the computer. In the described embodiments, these devices include a display screen 64, a printer 66 device, a hard disk drive, and a network interface. A keyboard controller is used to receive input from the keyboard and send decoded symbols for each pressed key to microprocessor over bus. The keyboard is used by a user to input commands and other instructions to the computer system. Other types of user input devices can also be used in conjunction with the present invention. For example, pointing devices such as a computer mouse, a track ball, a stylus, or a tablet to manipulate a pointer on a screen of the computer system. The display screen 64 is an output device that displays images of data provided by the microprocessor via the peripheral bus or provided by other components in the computer. The printer 66 device when operating as a printer 66 provides an image on a sheet of paper or a similar surface. The hard disk drive can be utilized to store various types of data. The microprocessor together with an operating system operate to execute computer code and produce and use data. The computer code and data may reside on RAM, ROM, or hard disk drive. The computer code and data can also reside on a removable program medium and loaded or installed onto computer system when needed. Removable program mediums include, for example, CD-ROM, PC-CARD, USB drives, floppy disk and magnetic tape. The network interface circuit is utilized to send and receive data over a network connected to other computer systems. An interface card or similar device and appropriate software implemented by microprocessor can be utilized to connect the computer system to an existing network and transfer data according to standard protocols.

### I. Controller.

The controller 20 is an entity that enrolls the issuers 40, and/or the acquirers 50 and/or the merchants 60, into the overall system. Each of the parties enrolled in the financial system of the controller 20 agree to a terms of use that sets various guidelines that each of the enrolled parties must comply with (e.g. financial standards, electronic funds transfer standards, specific equipment utilized for the transactions, Payment Card Industry Data Security Standard (PCI DSS), compliance to know your customer (KYC), anti-money laundering (AML) and anti-terrorism financing requirements and any other standards adopted by the controller 20). The issuer 40 and/or acquirer 50 may be comprised of the controller 20. In addition, the merchant 60 may be comprised of the controller 20. The controller 20 includes a computer system for communicating with the issuer 40, acquirer 50, merchant 60, payment terminal 62 and/or the customer 30 via the telecommunications network 12.

The computer system of the controller 20 includes a database that includes information for the issuer 40, acquirer 50, merchant 60, loan accounts for each customer 30, information for payment terminals 62 and the like. The communications between the parties (i.e. issuer 40, acquirer 50, merchant 60, customer 30) preferably are centralized with and directed by the controller 20. Furthermore, the transfer of funds preferably is centralized with and directed by the controller 20 between the parties. The controller 20 may also be a financial institution that the issuer 40 and/or acquirer 50 have financial accounts with to increase the efficiency of funds transfer. The controller 20 preferably provides the specifications for the payment terminal 62 specifically designed to communicate with the system organized, monitored and maintained by the controller 20.

For example, when the payment terminal 62 is directed by the merchant 60 or the customer 30 to provide information to the issuer 40, the payment terminal communicates to the acquirer 50 who is enrolled with the controller 20, the acquirer 50 then communicates the information to the controller 20 which verifies the information (e.g. customer 30 enrollment, account information, etc.) along with verifying the acquirer 50, and then the controller 20 forwards the information to the issuer 40 once everything is verified as proper. The reverse process occurs when the issuer 40 desires to provide information to the payment terminal 62 and/or merchant 60. Once the financial transaction is completed, the issuer 40 transfers the required funds to the controller 20 (e.g. via electronic funds transfer, wire transfer, ACH, etc.) and then the controller 20 transfers the funds to the acquirer 50. The merchant 60 and the acquirer 50 handle the transferred funds similar to any customer with their bank. The standards used by the controller 20 are widely used in the industry and predominantly emanate from the Financial Transaction Card Originated Messages ISO 8583 by the International Organization for Standardization (known as ISO).

As the central hub for information exchange, the controller 20 is able to police the financial transactions by verifying that all interested parties in the transaction are fully enrolled and preapproved by the controller 20 to ensure no fraud occurs in the system and to ensure that only qualified merchants 60, acquirers 50 and issuers 40 participate in the installment loan payment system authorized and controlled by the controller 20. Various types of fees may be paid to the controller 20 for the services provided by the controller 20 such as a percentage of each financial transaction, a monthly enrollment fee and the like.

The controller 20 is able to detect potentially fraudulent transactions and/or parties involved that are not complying with the terms of use as specified by the controller 20. Once such a party is identified, if they are enrolled with the controller 20, the controller 20 can suspend, cancel or flag their account with the controller 20.

### J. Telecommunications Network.

The present invention may be utilized upon any telecommunications network 12 capable of transmitting data including voice data and other types of electronic data. Examples of suitable telecommunications networks 12 for the present invention include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN). The present invention may communicate via a single telecommunications network 12 or multiple telecommunications networks 12 concurrently. Various protocols may be utilized by the electronic devices for communications such as but not limited to HTTP, SMTP, FTP and WAP (wireless Application Protocol). The present invention may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The present invention may also be utilized with online services and internet service providers.

The Internet is an exemplary telecommunications network 12 for the present invention. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

### K. Operation of Invention.

1. Enrollment.

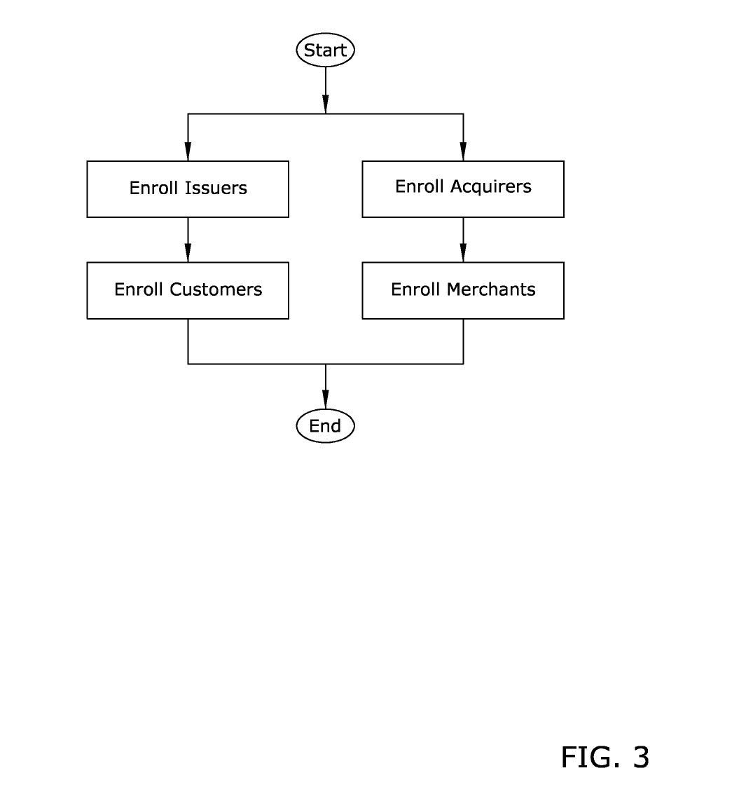

As illustrated in FIG. 3 of the drawings, one or more issuers 40 are enrolled with the controller 20. Also, one or more acquirers 50 are enrolled with the controller 20. In addition, one or more merchants 60 are enrolled with the acquirer 50. Enrollment may be comprised of various procedures that may or may not require a determination by the controller 20 as to whether the parties will be enrolled.

2. Preapproval of Customer.

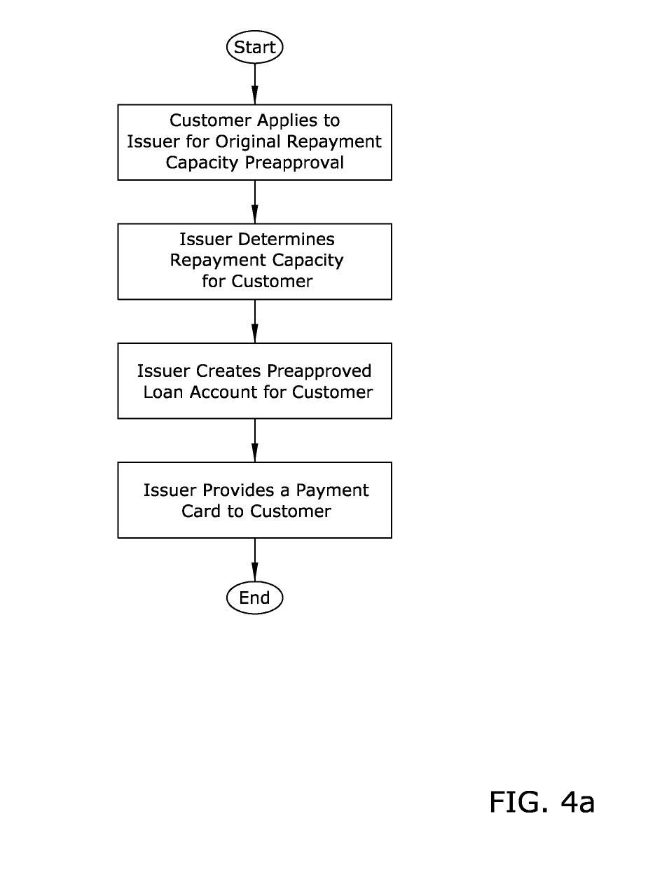

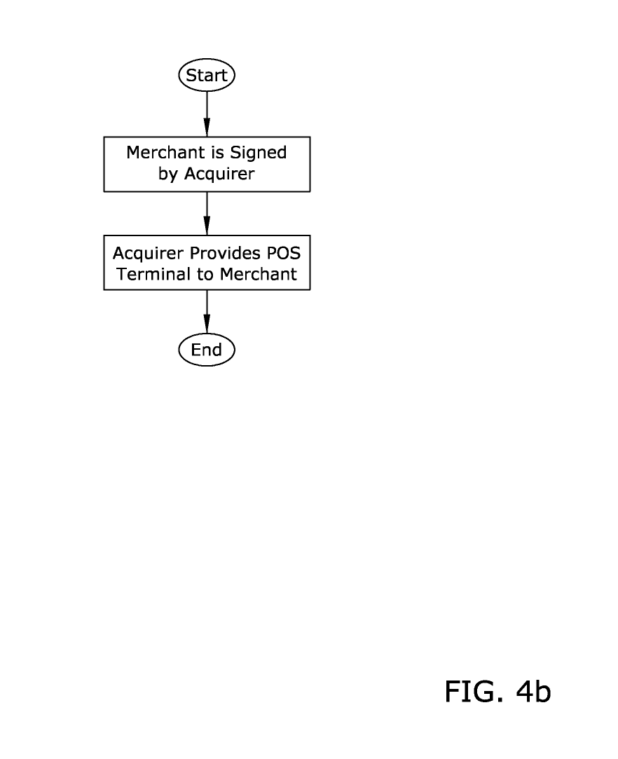

As illustrated in FIG. 4 of the drawings, one or more customers 30 are preapproved by the issuer 40 for respective individual loan accounts that each have an original repayment capacity as determined by the issuer 40. The customers 30 may apply for preapproval via a website, mobile phone application, in-person at the facility of the issuer 40, telephone, e-mail, or other suitable preapproval process. The issuer 40 verifies the original repayment capacity of the customer 30 based upon revenue for the customer 30 (e.g. monthly gross pay, yearly gross pay, monthly take-home pay, net income, etc.), existing debt obligations, credit history, credit score and the like. The issuer 40 may decide to decline a loan account for the customer 30 if the customer 30 does not have sufficient financial capacity as determined by the issuer 40. Enrollment may be comprised of various procedures that may or may not require a determination by the controller 20 as to why a customer 30 is enrolled or rejected.

If the issuer 40 approves the customer 30, the original repayment capacity is determined and the customer 30 is notified of the same. The issuer 40 further creates a preapproved loan account having an original repayment capacity for the customer 30 as illustrated in FIG. 4.

Once the customer 30 is preapproved, the customer 30 is provided with a payment card 32 associated with the loan account by the issuer 40. The payment card 32 includes an account identifier that is associated with the loan account for the customer 30. The payment card 32 also has an associated PIN or password required to be entered at a payment terminal 62 to authorize a loan transaction with the payment card 32 and associated loan account. The customer 30 may execute a master contract with the issuer 40 using whatever form acceptable to the Issuer 40 within its jurisdiction.

3. Selecting Item for Purchase.

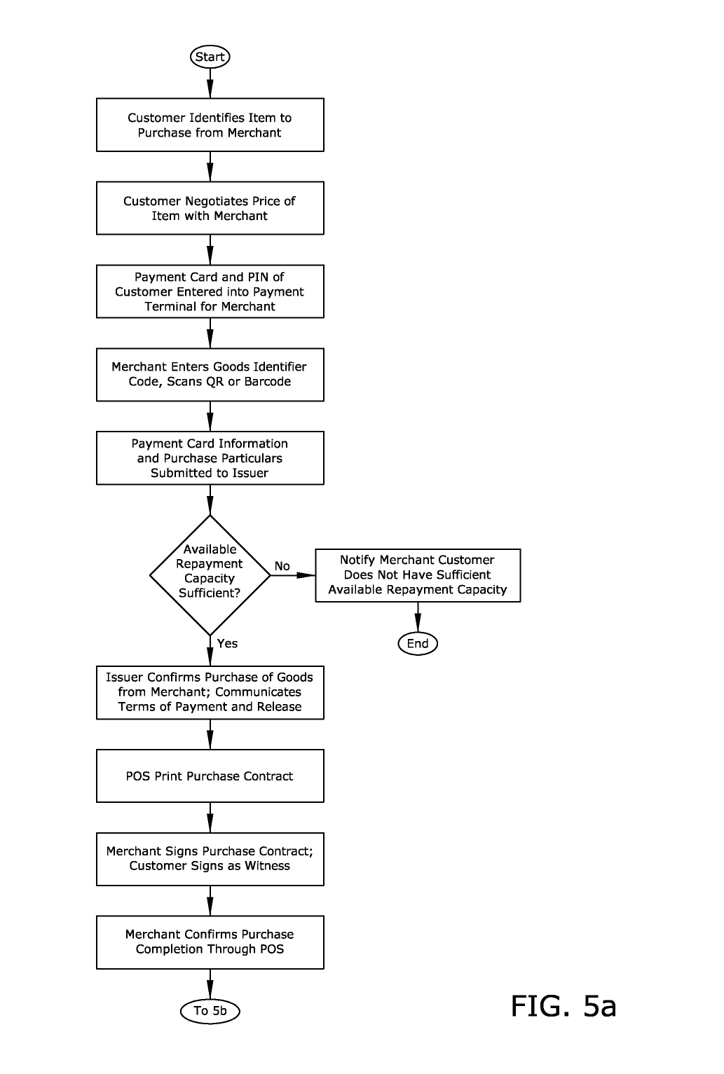

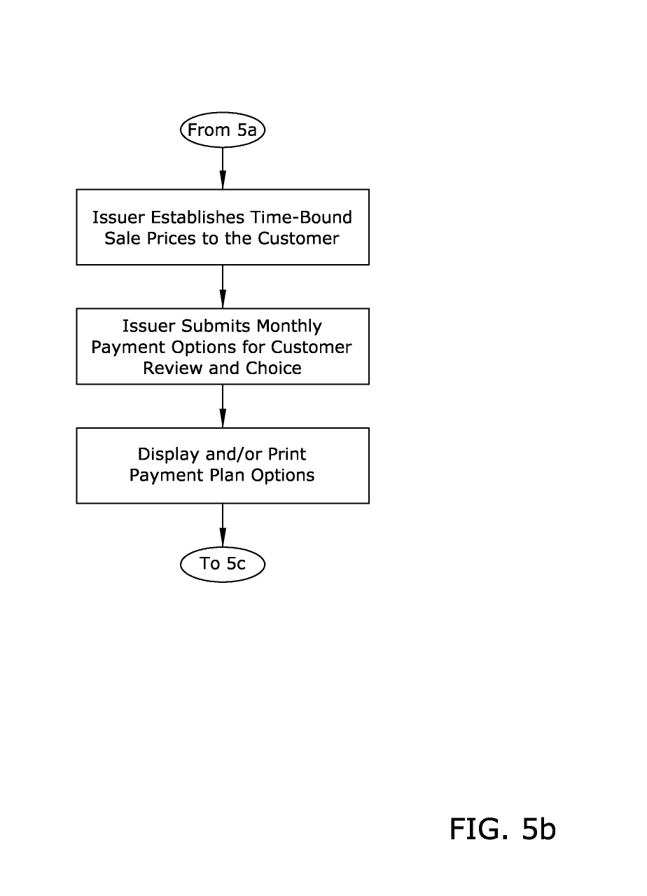

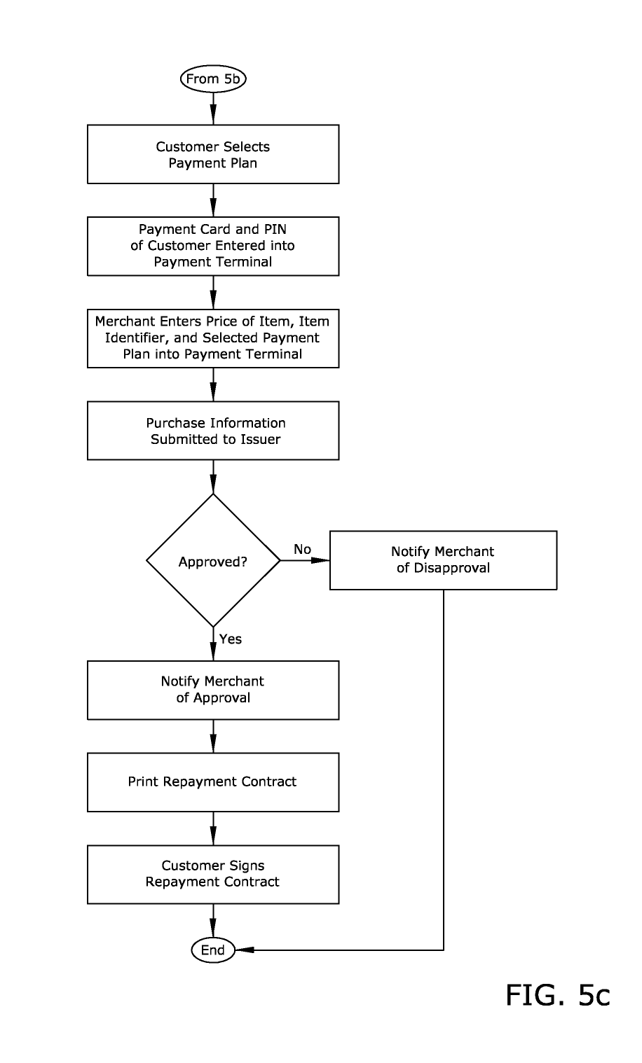

As shown in FIG. 5a of the drawings, the customer 30 identifies one or more items to purchase from a merchant 60. The customer 30 agrees with the merchant 60 regarding the purchase amount for the item(s) as is conventionally done when purchasing goods and/or services.

4. Requesting a Loan or Purchase from Issuer.

After the item for purchase has been identified, the customer 30 then requests a loan from the issuer 40 to pay for the item or requests the issuer 40 to purchase the item which involves transferring customer 30 data from the payment card 32 to a payment terminal 62 of the merchant 60. Some or all of the information from the payment card 32 is transferred to the payment terminal 62 by inserting the payment card 32 into a card reader 68 of the payment terminal 62, swiping the payment card 32 within a card reader 68 of the payment terminal 62, or positioning the payment card 32 near the card reader 68 for the wireless transfer of data such as using radio-frequency identification (RFID) technology. Alternatively, the account number may be manually entered into the payment terminal 62 via the keypad 69 of the payment terminal 62.

After the desired information from the payment card 32 has been input into the payment terminal 62, the customer 30 then is requested by the payment terminal 62 to enter their PIN or password. The customer 30 enters the PIN or password into the keypad 69 of the payment terminal 62 as illustrated in FIG. 5a of the drawings. The payment terminal 62 stores the data received from the payment card 32 and the customer 30 for later transmission or may transmit the data in real-time to the issuer 40 via the telecommunications network 12.

After the customer 30 has entered the payment card 32 and PIN/password into the payment terminal 62, the merchant 60 then enters the purchase amount for the item(s) and may also enter an identifier code for the purchase item(s) indicating what is being purchased as illustrated in FIG. 5a of the drawings. Such identifier code may be comprised of any kind of purchase item identifier such as but not limited to an optical machine-readable Barcode, a matrix barcode (or two-dimensional bar code, AKA Quick Response Code or “QR”) or other codes specific to various purchase items.

The information provided by the customer 30 and the merchant 60 is then submitted to the issuer 40 via the telecommunications network 12 thereby requesting the first loan for the customer 30 from the loan account. Alternatively, the information provided by the customer 30 and the merchant 60 is then submitted to the issuer 40 via the telecommunications network 12 thereby requesting the issuer 40 to purchase the goods in view of reselling them to the customer 30 as illustrated in FIG. 5a of the drawings. The issuer 40 receives the information from the payment terminal 62, identifies the customer 30 and associated loan account.

Based on the available repayment capacity of the customer 30, the issuer 40 then proceeds with the purchasing of the goods. The issuer 40 electronically confirms purchase of goods from the merchant 60 and communicates terms of payment and release of the goods to the merchant 60. The payment terminal 62 prints the purchase contract between the issuer 40 and the merchant 60. The merchant 60 signs Purchase Contract and the customer 30 may co-sign as a witness to the transaction. The merchant 60 confirms the transaction through the payment terminal 62 and the goods now belong to the issuer 40.

5. Requesting a Resale from the Issuer.

Under the Islamic embodiment of the present invention, after the item for purchase has been bought by the issuer 40, the issuer 40 can now resell the item to the customer 30 with a different price incorporating a profit margin. Based on the information already submitted, the issuer 40 establishes time-bound sale prices to the customer 30, together with monthly amounts that need to be reimbursed on a monthly basis by the customer 30. Such amounts need to be within the repayment capacity of the customer 30.

If this is the first time the customer 30 has requested a loan from the preapproved loan account, then the available repayment capacity will be equal to the original repayment capacity. However, if the customer 30 has one or more prior loans that the customer 30 is still making repayment thereof, then the available repayment capacity will be reduced accordingly, wherein the available repayment capacity is the remainder of the original repayment capacity for the loan account.

If the available repayment capacity is insufficient to provide the customer 30 with one or more payment plan options 70 (e.g. the available repayment capacity is $200 per month, but the lowest possible monthly payment allowed by the issuer 40 for the loan is $250), then the merchant 60 and/or customer 30 is notified (e.g. via the display screen 64 or printing the notice via the printer 66 of the payment terminal 62) by the issuer 40 that the customer 30 does not have sufficient available repayment capacity as shown in FIG. 5a of the drawings. The transaction is then canceled and the customer 30 is unable to purchase the item from the merchant 60.

6. Providing Payment Plan Options.

If the available repayment capacity is sufficient to one or more payment plan options 70 to be offered to the customer 30 from the issuer 40, then the available payment plan options 70 that are within the available repayment capacity are identified and submitted to the merchant 60 for disclosure to the customer 30 (e.g. via the display screen 64, printing via the printer 66, etc.). The one or more payment options are comprised of payment options having payments equal to or less than the available repayment capacity. The customer 30 is able to view and select the desired payment plan option that they prefer.

FIG. 8a illustrates an example of the payment plan options 70 being presented to the customer 30 via the display screen 64 of the payment terminal 62. As shown in FIG. 8a, Plan 1 is stricken-through with a line or other indication (e.g. red text) indicating that Plan 1 is not available to the customer 30. However, the customer 30 has Plans 2-8 available which all have different terms and monthly payments that are less than the available repayment capacity ($465.33). In addition, the display screen 64 optionally shows the original repayment capacity ($632.00) for the customer 30 and/or the available repayment capacity ($465.33) prior to the current purchase for the customer 30. In addition, the purchase amount ($3,000.00) for the item along with the interest rate (0.99% per month) for the loan is displayed on the display screen 64 and/or printed out for the customer 30 as shown in FIG. 8a. Alternatively, the purchase amount ($3,000.00) for the item along with the average profit rate (0.99%) for the loan is displayed on the display screen 64 and/or printed out for the customer 30 as shown in FIG. 10a of the drawings. The display screen 64 further provides the payment plan options 70 that have payments that are within the available repayment capacity for the customer 30 as illustrated in FIGS. 8a and 10a of the drawings. Optionally the resale amount for each plan is also displayed on the display screen 64 and/or printed out for the customer 30. If only one repayment plan option is available, then only one repayment plan option is shown to the customer 30. If more than one repayment plan is available, then all of the available repayment plans are preferably displayed to the customer 30 to provide various options for the customer 30. For example, Plan 2 illustrated FIG. 8a is for a term of 12 months with monthly payments of $279.70 and Plan 3 is for a term of 18 months with monthly payments of $196.37. For example, Plan 2 illustrated FIG. 10a is for a term of 12 months with monthly payments of $279.70 and an issuer 40 reselling price of $3,356.40 Plan 3 is for a term of 24 months with monthly payments of $154.70 and an issuer 40 reselling price of $3,712.80. All of the information illustrated in FIGS. 8a and 10a may also be printed out for the customer 30 for review and decision in addition to or instead of displaying upon the display screen 64 of the payment terminal 62. Also, the information illustrated in FIG. 8a may be directly provided to the customer 30 via a smart phone, computer or other electronic device of the customer 30 in addition to or instead of submitting the information to the payment terminal 62 wherein the customer 30 may select a payment plan directly with the issuer 40 instead of via the payment terminal 62.

7. Selecting and Finalizing a Payment Plan.

As shown in FIG. 5c of the drawings, the customer 30 reviews the available payment plan options 70 provided by the issuer 40 and then selects a payment plan for repaying the loan for the item that the customer 30 desires. If the customer 30 does not want to accept any of the payment plan options 70 presented, the customer 30 may cancel the transaction by selecting the “Cancel” button on the keypad 69 and the financial transaction is terminated.

The selected payment plan option is selected by the customer 30 via the payment terminal 62 (e.g. selecting Plan 2 by entering the number “2” button via the keypad 69 and then the “Enter” button). The customer 30 further preferably enters the payment card 32 again and the PIN/password associated with the payment card 32 to confirm the payment plan option the customer 30 is selecting as illustrated in FIG. 5c of the drawings. The merchant 60 then enters the purchase amount for the item, an item identifier (e.g. item code, scanning a quick response (QR) code or barcode) and the selected payment plan into the payment terminal 62 (it is optional for the merchant 60 to enter the payment plan option selected as the customer 30 preferably has the ability to enter the payment plan selected).

The selected plan and purchase information is then submitted to the issuer 40 for final approval of the loan and purchase. The issuer 40 determines whether to approve or disapprove the loan to the customer 30 for the purchase of the item as illustrated in FIG. 5a of the drawings. If the issuer 40 decides to disapprove the loan, the merchant 60 and customer 30 are notified of the disapproval. If the issuer 40 decides to approve the loan, the merchant 60 and customer 30 are notified of the approval along with being provided with an approval code as illustrated in FIGS. 5c and 8b of the drawings. The payment terminal 62 discloses the item name, item code, the payment plan selected, the monthly payments for the payment plan, the total purchase amount, the approval code, the interest rate (or profit rate under the Islamic embodiment of the present invention), the term of payments, the date of the first installment payment, the date of the last installment payment, legal terms for the customer 30 and a signature location. The payment terminal 62 displays this information upon the display screen 64 and preferably prints everything for the customer 30 to review and sign (the “repayment contract”). The signed terminal receipt is kept by both the customer 30 and merchant 60 and serves as an addendum to the master contract signed with issuer at the time of card issuance. The customer 30 may also execute the repayment contract with an electronic signature entered into a touchscreen or other electronic signature system.

The customer 30 is thereafter legally bound to the issuer 40 to make the required monthly payments. The customer 30 is then provided possession of the goods or provided the services. Once the issuer 40 receives confirmation that the repayment contract has been signed and executed by the customer 30, the appropriate funds are then transferred from the issuer 40 to the merchant 60 to purchase the item (the funds may be directly transferred via any funds transfer system to the merchant 60 or the acquirer 50 associated with the merchant 60).

8. Additional Item Purchases.

The above process (with the exception of preapproval by the customer 30) may be repeated numerous times to purchase future items as long as a payment plan is available that satisfies the current available repayment capacity for the customer 30. For example, if the customer 30 has an original repayment capacity of $632 per month and has taken out a first loan with monthly payments of $279.70, the available repayment capacity for the customer 30 is $352.30 per month. If the customer 30 takes out a second loan from the issuer 40 with monthly payments of $200 per month, then the available repayment capacity is lowered to $152.30 per month.

After the second loan from the loan account, the customer 30 is only able to take out a third loan if the payments are at or below $152.30 per month and so forth. If the customer 30 pays off the first loan, then the available repayment capacity will increase by the amount being paid for the first loan (i.e. $279.70).

The process continues without the customer 30 having to make specific preapproval requests from the issuer 40 as long as the customer 30 has sufficient available repayment capacity. The issuer 40 may adjust the original available repayment capacity and/or the available repayment capacity at any time as desired to reflect changes in the customer's income situation, credit history and/or repayment history.

9. Utilizing Smart Card for Approving Loans to Customer.

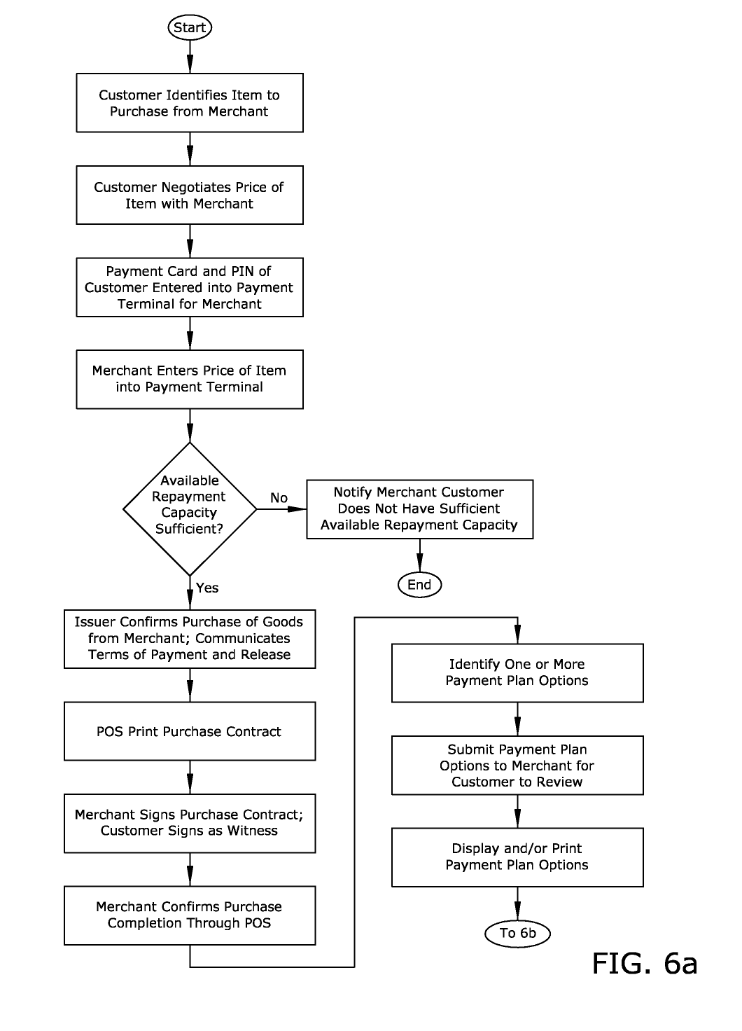

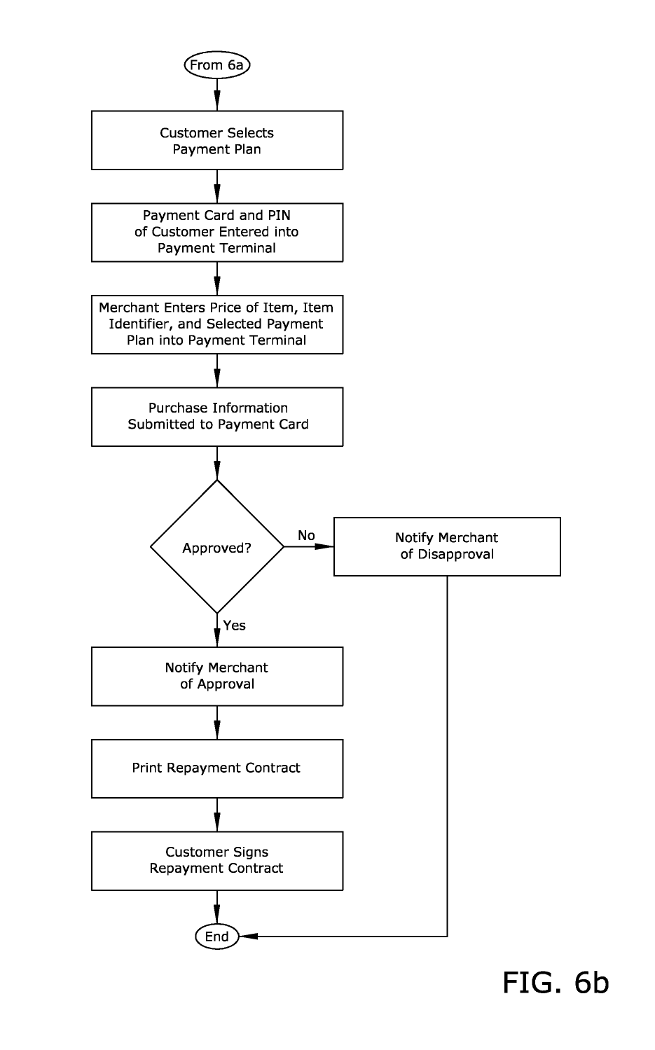

FIGS. 6a and 6b illustrate the usage of a smart card for the payment card 32 that includes an operating system that allows for running a chip application or program that performs the functions of the issuer 40 on its behalf without having to communicate directly with the issuer 40. For example, the payment card 32 would have the information for the customer 30 (e.g. customer name, account number, loan account identifier, original repayment capacity, available repayment capacity, past transactions history and the like). When the user communicates the payment card 32 to the payment terminal 62, the information entered into the payment terminal 62 is communicated to the payment card 32 and the chip application on the payment card 32 determines if the customer 30 has a sufficient available repayment capacity and also determines the available repayment plan options 70 similar to the discussion above except the issuer 40 is not directly involved. This increases the efficiency of the transaction and does not require an immediate communication connection between the payment terminal 62 and the issuer 40 (e.g. in remote areas where communication networks may not be completely reliable).

The chip application performs all of the required calculations as programmed by the issuer 40 and the transaction is completed accordingly as illustrated in FIGS. 6a and 6b of the drawings. The payment terminal 62 then communicates the details of the transaction to the issuer 40 so the issuer 40 may update the database within the issuer 40 accordingly for proper billing of the customer 30. The issuer 40 may update the chip application and data stored on the payment card 32 from time to time when the customer 30 communicates the payment card 32 to the payment terminal 62 via the telecommunications network 12.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

The invention claimed is:

1. A method of issuing a loan to a customer, comprising:
selecting an item for purchase by a customer from a merchant at a purchase amount, wherein said merchant is enrolled with a controller;
requesting a loan by said customer from an issuer enrolled with said controller;
providing said customer via said controller a plurality of payment plan options for repaying said loan that are within an available repayment capacity for said customer; and
selecting a payment plan by said customer for repaying said loan.

2. The method of claim 1, including the step of calculating an original repayment capacity for said customer.

3. The method of claim 2, wherein said step of calculating said original repayment capacity is performed by said issuer, wherein said issuer provides said loan to said customer via said controller.

4. The method of claim 2, wherein said original repayment capacity is comprised of a portion of revenues for said customer.

5. The method of claim 2, wherein said original repayment capacity is comprised of a monthly amount of money and wherein said loan includes a monthly payment for a term.

6. The method of claim 5, wherein said plurality of payment options are comprised of payment options having monthly payments equal to or less than said available repayment capacity.

7. The method of claim 5, wherein said available repayment capacity is comprised of said original repayment capacity reduced by a total of monthly payments for current loans to said customer.

8. The method of claim 1, including the steps of:
selecting a second item for purchase by said customer from a second merchant at a second purchase amount;
requesting a second loan by said customer;
providing said customer a second plurality of payment plan options for repaying said second loan that are within said available repayment capacity for said customer; and
selecting a payment plan by said customer for repaying said second loan.

9. The method of claim 1, including the step of transferring funds from said issuer to said merchant for said purchase amount after said step of selecting a payment plan.

10. The method of claim 9, including the steps of:
purchasing said item from said merchant by said issuer;
paying said merchant for said item by said issuer; and
reselling said item to said customer by said issuer.

11. A method of issuing a loan to a customer, comprising:
enrolling an issuer by a controller;
enrolling an acquirer by said controller;
preapproving a customer of said issuer for a loan account having an original repayment capacity, wherein said original repayment capacity is comprised of a maximum allowed total periodic payment from said customer to repay said loan account;
selecting an item for purchase by said customer from a merchant associated with said acquirer;
requesting a loan by said customer from said loan account;
calculating an available repayment capacity remaining of said original repayment capacity for said loan account;
providing said customer a plurality of payment plan options for repaying said loan that are within said available repayment capacity for said customer; and
selecting a payment plan by said customer for repaying said loan.

12. The method of claim 11, wherein said step of requesting a loan includes the step of submitting via a payment terminal to said issuer a price for said item and a customer identifier for said loan account.

13. The method of claim 12, including the step of providing said customer with a payment card associated with said loan account.

14. The method of claim 13, wherein said step of requesting a loan includes the step of providing payment information from said payment card and purchase information of said item to said payment terminal.

15. The method of claim 14, wherein said step of requesting a loan includes the step of transmitting said payment information and said purchase information from said payment terminal to said issuer.

16. The method of claim 13, wherein said payment card is comprised of a smart card that performs said step of calculating an available repayment capacity.

17. The method of claim 11, including the step of transferring funds from said issuer to said controller and then to said acquirer of said merchant to purchase said item.

18. A method of issuing a loan to a customer, comprising:
enrolling an issuer by a controller;
enrolling an acquirer by said controller;
preapproving a customer of said issuer for a loan account having an original repayment capacity, wherein said original repayment capacity is comprised of a maximum allowed total periodic payment from said customer to repay said loan account;
providing said customer with a payment card associated with said loan account;
selecting an item for purchase by said customer from a merchant associated with said acquirer;
transferring customer data from said payment card to a payment terminal of said merchant;
entering purchase amount of said item into said payment terminal;
requesting a loan by submitting via said payment terminal to said issuer via said controller said customer data and said purchase amount;
calculating an available repayment capacity remaining of said original repayment capacity for said loan account;
providing said customer a plurality of payment plan options for repaying said loan that are within said available repayment capacity for said customer, wherein said step of providing said customer a plurality of payment plan options is comprised of displaying and/or printing said plurality of payment plan options;
selecting a selected payment plan by said customer for repaying said loan;
submitting to said issuer said selected payment plan; and
executing a repayment contract by said customer for said loan.

19. The method of claim 18, including the step of transferring funds from said issuer to said merchant to purchase said item.

20. The method of claim 18, wherein said original repayment capacity is comprised of a monthly amount of money said customer is allowed up to for all monthly payments on all loans within said loan account.
